(19) United States
(12) Patent Application Publication
(10) Pub. No.: US 2015/0204122 A1
(43) Pub. Date: Jul. 23, 2015

(54) Portable Lock-down System

(71) Applicants: Curtis Lee Edwards, (US); Celisa Jeanette Edwards, Pendergrass, GA (US)

(72) Inventors: Curtis Lee Edwards, Pendergrass, GA (US); Celisa Jeanette Edwards, Pendergrass, GA (US)

(21) Appl. No.: 14/161,599

(22) Filed: Jan. 22, 2014

(51) Int. Cl. E05C 19/18

(52) U.S. Cl. CPC E05C 19/18

(57) ABSTRACT

A portable lock-down device, comprising of a loop or clasping device encircling or grasping a door handle or other fixed object on the door, a cable or other flexible material extending to a loop or cable attachment device allowing easy attachment and detachment to the fixed primary eyebolt via a spring coupling device, said portable lockdown device passes through an eyebolt or collapsible ring adjacent to the doors edge, coupling to the primary eyebolt, mounted in the wall, well out of reach of an intruder, provides classroom security.

The Portable Lock-down System is registered under provisional patent application No. 61/755,059 with the title reading Lock-down Lead.

### FIELD OF THE INVENTION

The device consists of an anchor, a tether, a grasp and a catch.

The present invention relates generally to a portable tethering device which attaches any swinging or sliding mechanism to a solid surface. More specifically to a portable cable or cord (the tether) attached between the handle or other fixed object on the door via the catch and an eyebolt or other attachment secured to the wall or floor (the anchor) by the grasp.

When properly attached, the door will not be able to open inward, outward, or slide until the assembly is disengaged.

The only limiting factors are the anchor used, the strength of the assembly, and the attachment to the door itself. Varying levels of security needed will dictate varying levels of strength of the devices

### BACKGROUND OF THE INVENTION

The conventional “Adjustable Chain Door” encompasses the use of a slide bracket that is anchored to the door and a second bracket that is anchored to an adjacent wall, such that a chain may be detachably coupled to the slide bracket through a coupling element.

In a school environment these devices fail in varying ways. First the classroom doors have windows. Breaking the window will allow the intruder to unhook such devices. A lockdown device must be engaged beyond the reach of an intruder. Second, because these devices are permanently attached, the devices may be engaged by student and intruders alike, locking out teachers and/or administrators. The device must be detachable and not accessible to non-authorized users. Third, engaging supplemental locking devices can be slow and/or cumbersome. A lockdown device must attach in seconds to allow prompt security in such instances as needed.

All the following devices found from the patent search fail in one or more of the above requirements.

U.S. Pat. Nos. 3,804,454, 4,079,973, 4,155,577, 4,288,119, 4,478,442

The preceding patents fail in that they can be dis-engaged through a compromised window and can be engaged by a student/intruder.

U.S. Pat. No. 5,716,084

Per drawing is unclear in its total use however:

the ability to dis-engage the device through a compromised window and the engagement by a student/intruder both make it unsuitable for a school situation.

Our patent search was unable to come up with a suitable device for this use.

Therefore, it is readily apparent that there is a recognizable unmet need for a device that attaches in seconds, is capable of securing a door even when a window in the door is penetrated, that is inaccessible for improper use by students, and that provides security without the teacher opening the door accessing the hall. All the above potential hazards are eliminated by this device. Additionally, this device works no matter what direction the door swings.

### BRIEF SUMMARY OF THE INVENTION

Briefly described, in a preferred embodiment, the present apparatus overcomes the above-mentioned disadvantage(s), and meets the recognized need for such an apparatus by providing, a portable lock down device, in general, a first loop or grappling device attached to a door handle, a cable extending to, a second loop, encircling a spring loaded coupling device, said portable lock down device may pass through an eyebolt adjacent to the doors edge(providing additional security, and necessary on internal swinging doors), coupling to a second eyebolt, mounted in the wall, well out of reach of an intruder.

According to its major aspects and broadly stated, the present apparatus in its preferred form is a portable lock down device, comprising a cable with dual loops able to fit in any locked drawer or portable carrying device such as a briefcase or purse; The portability prevents the students from locking a teacher and/or administration out of said classroom.

More specifically, the preferred embodiment of the present apparatus further comprising specifically, a spring coupling mechanism attached to the second loop end, said end attaches to a single eyebolt on out swinging doors.

Accordingly, a feature of the present portable lock down device when mounted on an in swinging door, the cable passes through a secondary eyebolt, close to the doors edge, limiting its swing, while coupling to a primary eyebolt out of an intruders reach.

Another feature of the present portable lock down device is, in the event of a breach in the classroom door's window, an intruder cannot uncouple the spring loaded device, it is out of reach.

Another feature of the present portable lock down device is the cable is slightly flexible limiting the impact of a sudden force applied to the door.

Another feature of the present portable lock down device is the relatively ease of installation and minimal cost, as opposed to waiting for the approval of retooling all the school locks and still having the window breach problem.

Another advantage of the present portable lock down device is the prevention of the teacher going into a danger zone outside the classroom to secure the door, many school locks were specifically designed without an interior locking capability. Additionally, the reason for these door locks, without interior locking capabilities, was to prevent anyone from restricting a teacher from entering his or her classroom. This is retained by the portability of the device.

Yet another advantage of the present portable lock-down device is the prevention of the need for a teacher to barricade the doors in the case of a lockdown, which in practice is cumbersome and risk injury from weighty objects, such is impractical for drills as well. While this action might slow down the intruder with an in-swinging door, it is virtually useless in an out swinging door application that is designed in many schools.

Still another advantage of the present portable lock-down device is the relief felt by the teacher and the students during a school intrusion, any amount of stress relief in these situations is gratifying.

Preferred and Selected Alternate Embodiments; the secondary eyebolt or collapsible ring is only necessary on internal swinging doors. However the inclusion of this ring on external swinging doors provides a greater level of security in some instances for removal of the grasp from the door handle thus is optional on external swinging doors. The material described in this specification is not intended to be specific in type but rather in purpose. The means of attachment and products used for tethering may vary and provide varying levels of security.

These and other features of the portable lock down device will become more apparent to one skilled in the art, from the following Brief Description of the Drawings, the Detailed Description of the Invention and Claims when read in light of the accompanying drawing Figures.

### BRIEF DESCRIPTION OF THE DRAWINGS

The present portable lock down device will be better understood by reading the Detailed Description of the Preferred and Selected Alternate Embodiments with reference to the accompanying drawing figures, in which like reference numerals denote similar structure and refer to like elements throughout, and in which:

FIG. 1 is a front view of a portable carrying device with the lock down cable enclosed;

FIG. 1.1 a prior art classroom door assembly showing a breached window, an in swinging door, and the portable lock down devices mounting system;

FIG. 1.2 is an enlarged perspective view showing a portable lock down devices mounting system in FIG. 1.1 in the secure state;

FIG. 1.3 is a top perspective view of a portable lock down device preventing the door from opening according to a preferred embodiment;

FIG. 2 is a perspective view of portable lock down devices mounting system with an out swinging door;

FIG. 2.1 is a top perspective view of a portable lock down device preventing an out swinging door from opening according to a preferred embodiment;

### DETAILED DESCRIPTION OF THE INVENTION

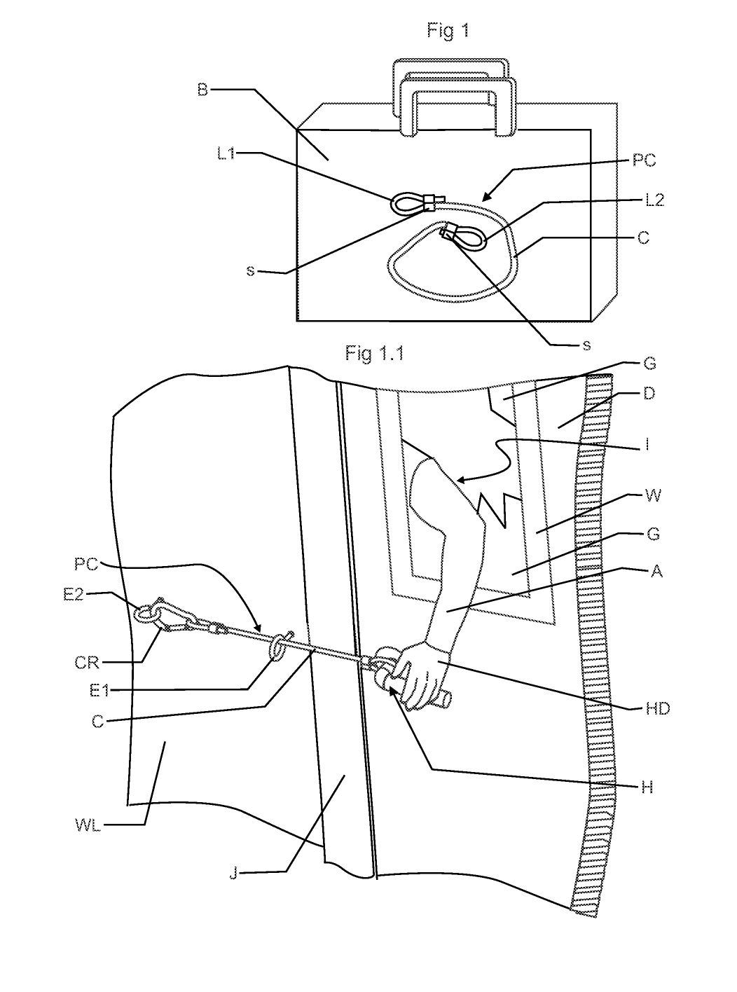

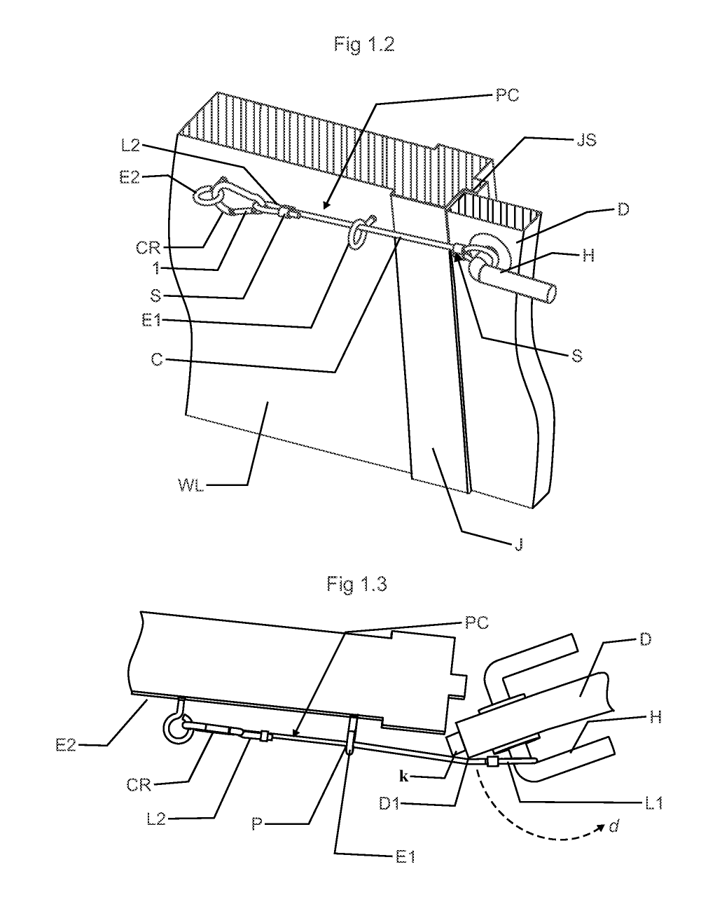

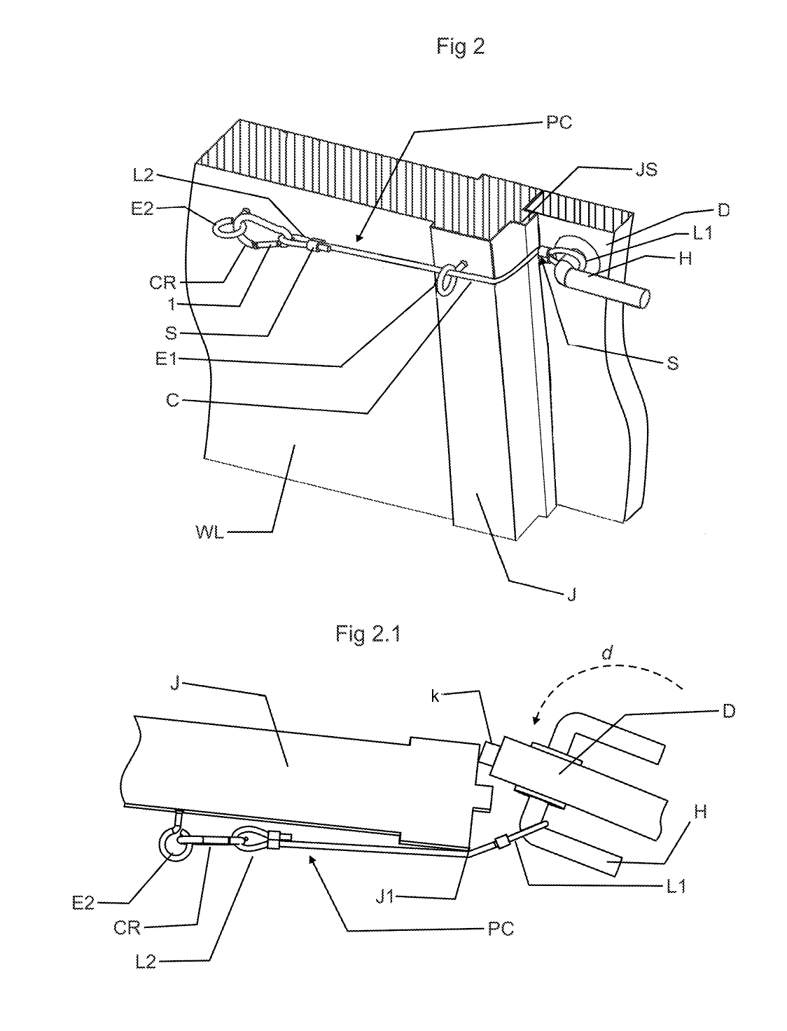

In describing the preferred and alternate embodiments of the present invention, as illustrated in FIGS. 1-2 specific terminology is employed for the sake of clarity. The present invention, however, is not intended to be limited to the specific terminology so selected, and it is to be understood that each specific element includes all technical equivalents that operate in a similar manner to accomplish similar functions. Such as an alternate attachment to the door itself do to handle variations and frailty or alternate attachments to the wall and/or floor due to limitations unknown by varying substrates.

Referring now to FIG. 1 there is depicted a prior art brief case B, Portable cable PC, with prior art cable C, with first loop L1, formed an secured by swag S, with second loop L2 formed in a similar fashion;

Referring now to FIG. 1.1, is a prior art classroom door assembly, comprising Door D, breached window W, Broken glass G, door handle H, with intruder I, consisting of arm A, and hand HD, trying to unlock handle H; wall WL, has door jam J, with closed door D, with door handle H, being unlocked By intruder I, Portable cable assembly PC, is preventing access by first loop or grasping device L1, encircling or grasping handle H, cable C, passing through secondary eyebolt or collapsing ring E1, with second loop L2, encircling spring carabineer CR, spring carabineer CR, is clipped on primary eyebolt E2, well out of the reach of intruder I;

Referring now to FIG. 1.2 is an enlarged cutaway perspective view shown in FIG. 1.1 with door D, in the closed state; jam J, has a protruding edge JS, that acts as a stop for the in swinging door D, held snuggly into jam J, by door strike k, shown in FIG. 1.3, in this position first end L1, formed by swag S, of portable cable assembly PC, loops over handle H, extended cable C, has second end L2, held taught by spring loaded coupling device CR, encircling eyebolt E2;

Moreover, eyebolt E2, spring loaded coupling device CR, come in an endless variety of types, shapes, sizes and purposes, preferably said fasting device is not limited, cable C, includes other suitable characteristics, in an endless variety of types, such as durability, water-resistance, light weight, malleable, oxidation resistance, ease of workability, or other beneficial characteristic understood by one skilled in the art;

Referring now to FIG. 1.3 is an enlarged perspective top view shown in FIG. 1.2 with door D, held slightly ajar, Door D, is prevented from opening in direction d, because eyebolt E1, is causing cable C, to bend at edge D1, eyebolt E1, is within reach of intruder I, shown in FIG. 1.1, door D, is prevented from opening farther by Point P, on eyebolt E1; loop L2, of portable cable assembly PC, is attached to eyebolt E2, well out of reach of intruder I, shown in FIG. 1.1 as described in FIG. 1.2;

Referring now to FIG. 2 is a perspective view of an out swinging door in the closed state; jam J, has a protruding edge JS, that acts as a stop for out swinging door D, L1 encircles H handle with cable C passing through E1 (optional eyehook or collapsible ring for out swinging doors) with L2 attached to E2 with spring loaded coupling device CR. Thus preventing door opening as shown in FIG. 2.1, indicated by motion d, door D, is prevented from opening by in this position cable first Loop L1, of portable cable assembly PC, and is held taught by second loop L2, encircling spring carabineer CR, said carabineer CR encircles eye bolt E2, door D cannot open regardless of release by door strike k.

1-3. (canceled)

4. Be it known that we have invented a portable lockdown device that consists of an anchor, a tether, a grasp, a pivot and a catch which provides a secondary security when the locked door has been breached with limited alteration and infringement to the classroom

5. We have invented a portable lock down device with said catch that attaches in seconds, to said anchor making simple, effective and urgent protection available to teachers.

6. We have invented a portable lock down device with said pivot or secondary ring consisting of an eyebolt or collapsible ring adjacent to the door that enhances breach prevention for in or out swinging doors.

7. We have invented a portable lock down device that comprises breach prevention for in or out swinging doors with a said tether attached to coupling device which attaches to an eyebolt out of reach of a classrooms door's breached window.

8. We have invented a portable lock down device that comprises of an extended tether with a double loop for securing both to the door via the door handle or other fixed attached device and to the classrooms adjacent wall such that device may only be released by first detaching the end attached to the wall out of reach of the said window.

9. We have invented a portable lock down device that comprises of a primary eyebolt well out of reach of an intruder with the access to the door handle, and secondary eyebolt adjacent to the door jam.

10. We have invented a lockdown device that is portable and creates security without need for teacher to open door or exit classroom securing the classroom from within from any and all external influences.

11. a lock down device that is portable and will fit in a small pouch, a locked drawer, brief case or purse thus preventing the use by students and unauthorized users.
